(19) United States
(12) Patent Application Publication
(10) Pub. No.: US 2015/0343616 A1
(43) Pub. Date: Dec. 3, 2015

(54) HAMMERING SET FOR AN IMPACT TOOL

(71) Applicant: SOARTEC INDUSTRIAL CORP., Taichung (TW)

(72) Inventor: Chun-Tien Chen, Taichung (TW)

(73) Assignee: SOARTEC INDUSTRIAL CORP., Taichung (TW)

(21) Appl. No.: 14/294,595

(22) Filed: Jun. 3, 2014

(51) Int. Cl. B25B 21/02; F16J 15/16; B25D 17/26

(52) U.S. Cl. CPC B25B 21/02; B25D 17/26; F16J 15/16

(57) ABSTRACT

A hammering set has a rotating portion including a sidewall, two end walls connected to the sidewall, and at least one pivot portion in an accommodating space of the rotating portion. Two corresponding holes are disposed on the sidewall and communicating with the accommodating space. A shaft hole is disposed on one the end wall, a connecting portion is disposed on the other end wall for a rotating shaft. A hammering block has a through hole and a pivoting part on the pivoting portion and only swingable about the pivoting portion. A transmission shaft penetrates the shaft hole and the through hole, is rotatably disposed in the rotating portion, and is intermittently actuatable by each hammering block. A sealing assembly is provided on the rotating portion, at least seals the holes and is sealed between an inner wall of the shaft hole and the transmission shaft.

### BACKGROUND OF THE INVENTION

1. Field of the Invention

The present invention relates to a hammering set, and particularly to a hammering set for an impact tool.

2. Description of the Prior Art

Generally, a conventional rotary impact tool performs in a manner that a hammering set is driven by an electric or pneumatic motor impact tool to rotate. An impact mechanism, such as a hammering block and a hammering frame, is disposed in the hammering set and can provided impact force, and the frontal end of the hammering set can output rotary power for use. In the hammering set, a pin is inserted to one side of the hammering block and another side of the hammering block has a limiting portion for abutting with the hammering frame, so that the hammering block is limitedly swingable and can be controlled within a range. The hammering block impacts a transmission shaft to produce impact force. Additionally, to avoid that the hammering block and the transmission shaft being damaged by friction therebetween, quantity of lubricant is, generally, filled into the hammering set to prolong the hammering set's service life. TWM379496 and TW261039 disclose devices like that kind of the above-mentioned conventional impact tool.

The conventional hammering set does not has any elements to prevent leakage of lubricant from the interior thereof, and lubricant can leak from gaps between constructional parts, thus it requires refilling of lubricant after a period of time. However, operator may forget to refill lubricant into the hammering set regularly so that the hammering set will perform with poor efficiency or even be damaged. Moreover, refilling of lubricant is a complicated task and time-consuming.

The present invention is, therefore, arisen to obviate or at least mitigate the above mentioned disadvantages.

### SUMMARY OF THE INVENTION

An object of the present invention is to provide a hammering set for an impact tool, which effectively prevents leakage of lubricant from gaps between parts and does not require refilling of lubricant after a period of time.

To achieve the above and other objects, a hammering set for an impact tool is provided. The hammering set includes a rotating portion, at least one hammering block, a transmission shaft and a sealing assembly. The rotating portion defines an accommodating space. The rotating portion includes a circumferential wall, two corresponding end walls connected to the circumferential wall and at least one pivot portion located in the accommodating space. The circumferential wall is provided with two corresponding holes communicating the accommodating space. One the end wall provided with a shaft bore, and the other end wall is provided with a connecting portion for connecting to a rotating shaft of the impact tool. The at least one hammering block is received in the accommodating space, and each hammering block is provided with a through hole and a pivoting portion pivoted to the pivot portion. Each hammering block is only swingable about the pivoting portion. The transmission shaft penetrates through the shaft bore and each through hole, and the transmission shaft is rotatably disposed in the rotating portion and intermittently actuatable by each hammering block. The sealing assembly is provided on the rotating portion, and the sealing assembly at least seals the two holes and is sealed between an inner wall of the shaft bore and the transmission shaft.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view according to a preferred embodiment of the present invention;

FIG. 2 is a breakdown drawing according to a preferred embodiment of the present invention;

FIG. 3 is a cross-sectional view according to a preferred embodiment of the present invention;

FIG. 4 is a cross-sectional view according to an alternative preferred embodiment of the present invention;

FIG. 4A is a cross-sectional view according to another preferred embodiment of the present invention;

FIG. 5 is a breakdown drawing according to an alternative preferred embodiment of the present invention.

### DETAILED DESCRIPTION OF THE PREFERRED EMBODIMENTS

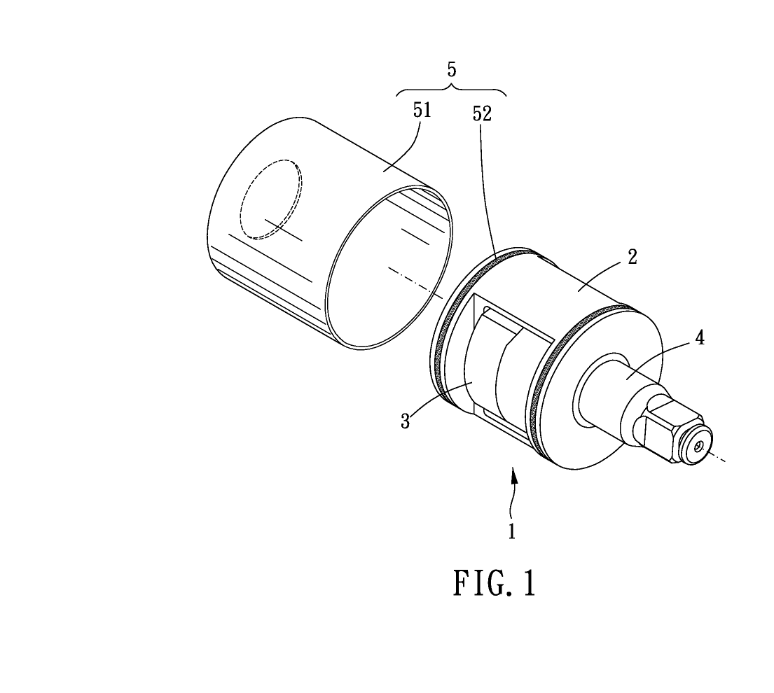

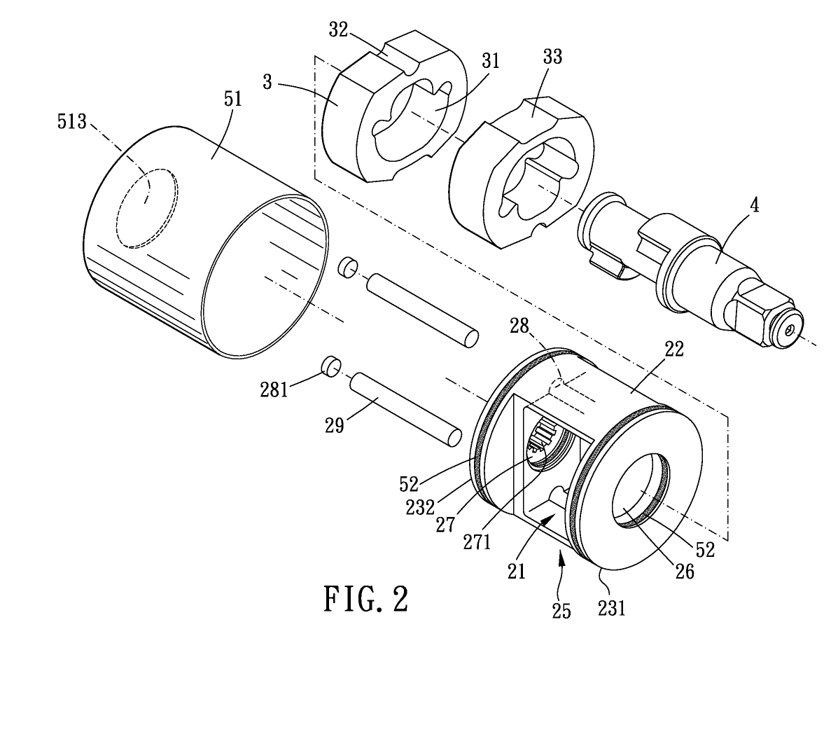

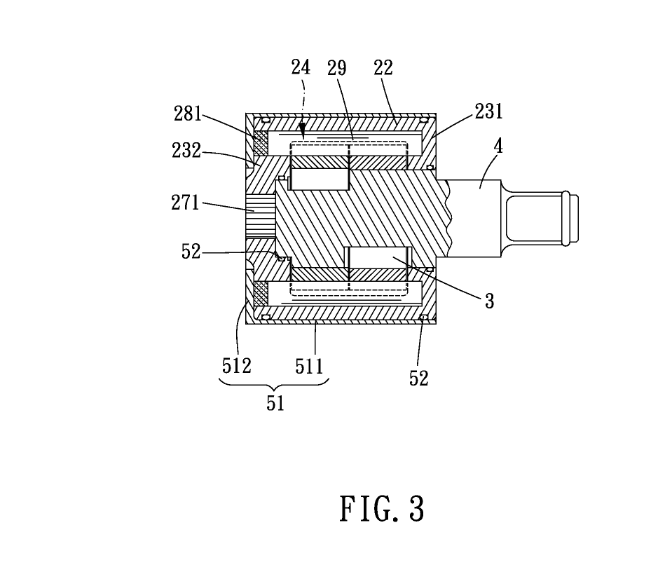

FIGS. 1-3 show a hammering set for an impact tool according to a preferred embodiment of the present invention. The hammering set 1 including a rotating portion 2, at least one hammering block 3, a transmission shaft 4 and a sealing assembly 5.

The rotating portion 2 defines an accommodating space 21. The rotating portion 2 includes a circumferential wall 22, two corresponding end walls 231, 232 connected with the circumferential wall 22, and at least one pivot portion 24 located in the accommodating space 21. In this embodiment, two of the pivot portions 24 are provided, and the circumferential wall 22 is provided with two corresponding holes 25 communicating the accommodating space 21. One the end wall 231 is provided with a shaft bore 26, the other end wall 232 is provided with a connecting portion 27 for connection of a rotating shaft of an impact tool. The connecting portion 27 is a key slot 271 penetrating the other end wall 232 and for assembling of the rotating shaft. Each pivot portion 24 is a projection axially extending in the accommodating space 21. Specifically, the other the end wall 232 is provided with at least one through bore 28, and the number of the through bore 28 is equal to that of the pivot portion 24. Each pivot portion 24 is a pin 29 and disposed through each through bore 28 to form the projection.

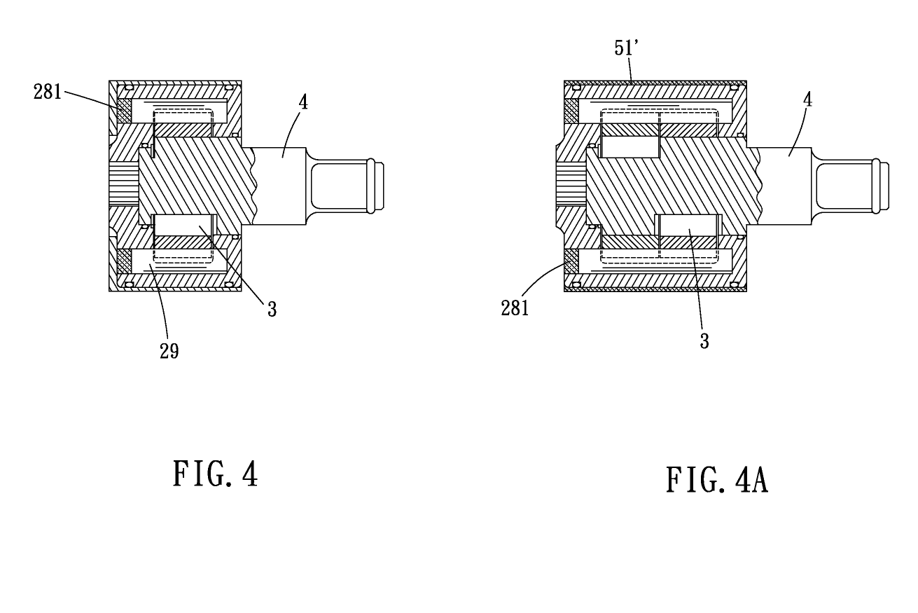

In this embodiment, two of the hammering blocks 3 are provided; however, in an alternative embodiment the number of the hammering block 3 may be one (as shown in FIG. 4). Each hammering block 3 is received in the accommodating space 21, and each hammering block 3 is provided with a through hole 31 and a pivoting portion 32 pivoted with corresponding pivot portion 24. The pivoting portion 32 is a recess and corresponds to the projection in shape. Each pin 29 is disposed through each through bore 28 and pivoted with the recess. A limiting groove 33 is located at a side opposite to the pivoting portion 32 of corresponding hammering block 3, for limitation to each pin 29, so that each hammering block 3 is only swingably about each pivot portion 24. It is noted that each pin 29 and each hammering block 3 may be integrally formed and is disposed in the accommodating space 21.

The transmission shaft 4 penetrates through the shaft bore 26 and each through hole 31, and is rotatably disposed in the rotating portion 2 and intermittently actuatable by each hammering block. When the hammering set 1 is coupled with the impact tool, the rotating shaft can drive the rotating portion 2 rotating and each hammering block 3 in the rotating portion 2 impacts the transmission shaft 4 intermittently, so that the transmission shaft 4 can provide intermittent rotation.

The sealing assembly 5 is provided on the rotating portion 2. The sealing assembly 5 at least seals the two holes 25 and is sealed between an inner wall of the shaft bore 26 and the transmission shaft 4. Specifically, the sealing assembly 5 includes an outer sleeve 51 and at least two sealing members 52. In this embodiment, four of the sealing members 52 are provided. The outer sleeve 51 includes a tubular body 511 disposed around the circumferential wall 22 and an end plate 512 connected with one end of the tubular body 511. The two sealing members 52 are respectively sealed between the tubular body 511 and the two end walls 231, 232. One the sealing member 52 is sealed between the inner wall of the shaft bore 26 and the transmission shaft 4, and the other sealing member 52 is sealed between the key slot 271 of the other end wall 232 and the transmission shaft 4, thus preventing leakage of lubricant from the shaft bore 26 and the key slot 271. In this embodiment, the sealing member 52 located between the inner wall of the shaft bore 26 and the transmission shaft 4 and the sealing member 52 located between the key slot 271 and the transmission shaft 4 are provided on the rotating portion 2. In other embodiment, the two sealing members 52 may be disposed on the transmission shaft 4. The end plate 512 is provided with an opening 513 corresponding to the connecting portion 27 for the rotating shaft to penetrate through the opening 513 to assemble with the connecting portion 27. The two sealing members 52 are disposed between the tubular body 511 and the two end walls 231, 232 to seal the two holes 25, for preventing leakage of lubricant from the two holes 25. Each through bore 28 is covered by a cover 281, and each cover 281 is disposed between the other the end wall 232 and the end plate 512. Each cover 281 is used to block each through bore 28 so as to prevent leakage of lubricant from each through bore 28. In this embodiment, with press of the end plate 512, each cover 281 can be tightly retained between the other the end wall 232 and the end plate 512. In an alternative embodiment, an outer sleeve 51′ may be provided without an end plate (as shown in FIG. 4A), and still each cover 281 can prevent leakage of lubricant from each through bore 28. Alternatively, the tubular body 511 of the outer sleeve 51 may be an elastically-deformable member such as a plastic or rubber member integrally connected to the rotating portion 2. As a result, the sealing assembly 5 may be provided without two of the sealing members 52 between the tubular body 511 and the two end walls 231, 232, and leakage of lubricant from the two holes 25 can be prevented too.

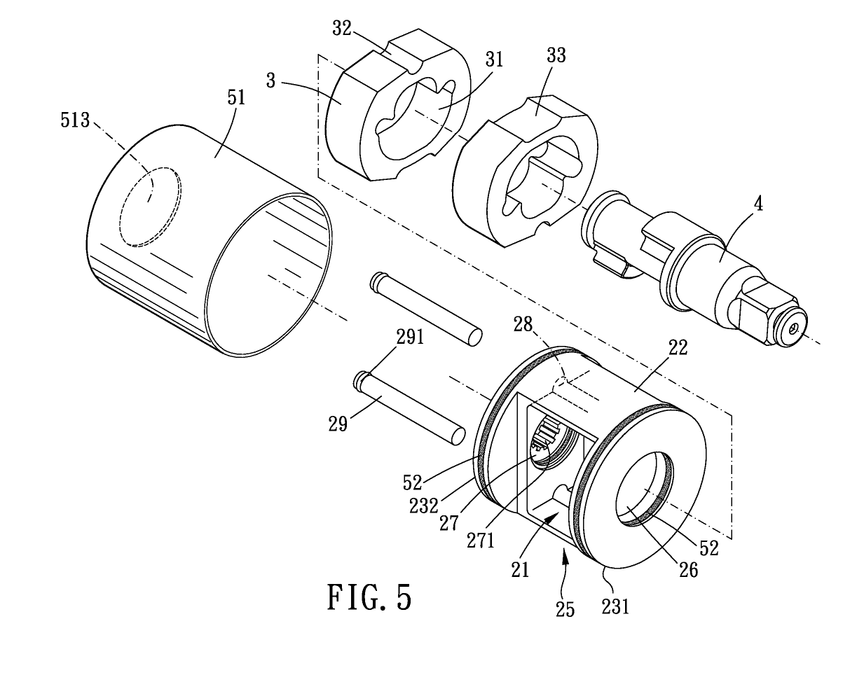

As shown in FIG. 5, in other embodiment, each cover 281 may be omitted, and each pin 29 may be provided with an annular groove at a periphery of one end near corresponding through bore 28, and each annular groove receives a gasket 291, in which the gaskets 291 can be perfectly sealed between each pin 29 and the other end wall 232. In other embodiment, the end wall 231 may be provided with the through bores 28, so that each pin 29 may be inserted into or detached from each through bore 28 of the end wall 231 or the other the end wall 232.

Given the above, the hammering set of the present invention includes the sealing assembly, thus effectively preventing leakage of lubricant from gaps between parts. As a result, it does not require refilling of lubricant after a period of time.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A hammering set for an impact tool, including:
a rotating portion, defining an accommodating space and including a circumferential wall, two corresponding end walls connected to the circumferential wall and at least one pivot portion located in the accommodating space, the circumferential wall provided with two corresponding holes communicating the accommodating space, one the end wall provided with a shaft bore, the other end wall provided with a connecting portion for connecting to a rotating shaft of the impact tool;
at least one hammering block, received in the accommodating space, each hammering block provided with a through hole and a pivoting portion pivoted to the pivot portion, each hammering block being only swingable about the pivoting portion;
a transmission shaft, penetrating through the shaft bore and each through hole, rotatably disposed in the rotating portion, and intermittently actuatable by each hammering block; and
a sealing assembly, provided on the rotating portion, at least sealing the two holes and sealed between an inner wall of the shaft bore and the transmission shaft.

2. The hammering set for an impact tool of claim 1, wherein the pivot portion is a projection which axially extends in the accommodating space, and the pivoting portion is a recess which corresponds to the projection in shape.

3. The hammering set for an impact tool of claim 2, wherein one the end wall is provided with a through bore, the pivoting portion is a pin, the pin is disposed through the through bore and pivoted with the recess, and the through bore is covered by a cover.

4. The hammering set for an impact tool of claim 1, wherein the connecting portion is a key slot penetrating the other end wall and for assembling of the rotating shaft, and the sealing assembly is sealed between the other end wall and the transmission shaft.

5. The hammering set for an impact tool of claim 1, wherein the sealing assembly includes an outer sleeve and at least two sealing members, the outer sleeve includes a tubular body disposed around the circumferential wall and an end plate connected with one end of the tubular body, the end plate is provided with an opening corresponding to the connecting portion, and the at least two sealing members are respectively sealed between the tubular body and the two end walls.

6. The hammering set for an impact tool of claim 5, wherein one the end wall is provided with a through bore, the pivoting portion is a pin, the pin is disposed through the through bore and pivoted with the recess, the through bore is covered by a cover, and the cover is disposed between one the end wall and the end plate.

7. The hammering set for an impact tool of claim 1, wherein the sealing assembly includes an outer sleeve and a sealing member, the outer sleeve includes a tubular body sealingly attached on the circumferential wall, and the sealing member is sealed between an inner wall of the shaft bore and the transmission shaft.

8. The hammering set for an impact tool of claim 7, wherein the tubular body is an elastically-deformable member.

9. The hammering set for an impact tool of claim 7, wherein the tubular body is a plastic or rubber member integrally connected to the rotating portion.
